(19) United States
(12) Patent Application Publication
(10) Pub. No.: US 2026/0077618 A1
(43) Pub. Date: Mar. 19, 2026

(54) ULTRA HIGH-CAPACITY MOBILE PLATFORM

(71) Applicant: Palvannanathan Ganesan, Omaha, NE (US)

(72) Inventor: Palvannanathan Ganesan, Omaha, NE (US)

(21) Appl. No.: 19/401,831

(22) Filed: Nov. 26, 2025

(51) Int. Cl. B60B 19/12; B60B 19/08; B60P 3/00; G21D 1/02

(52) U.S. Cl. CPC B60B 19/12; B60B 19/08; B60P 3/00; G21D 1/02; B60B 2360/102; B60B 2900/711

(57) ABSTRACT

A system configured to transport heavy loads is disclosed. The system may include a mobile assembly configured to support a load and to translate the load along a ground. The mobile assembly may include a platform having an upper surface configured to support the load and an underside surface opposite the upper surface. The mobile assembly may include a plurality of rollers configured to be disposed below the underside surface between the underside surface of the platform and the ground. The plurality of rollers may be configured to support the platform and rotatably translate along the ground to thereby translate the platform along the ground.

### TECHNICAL FIELD

The present disclosure relates generally to transport systems for heavy loads, and, more particularly, to mobile assemblies including roller-based mechanisms for translating ultra-heavy loads across ground surfaces.

### BACKGROUND

Ultra-heavy loads exceeding several thousand metric tons present significant challenges for ground-based transportation. Conventional wheeled transport vehicles may experience excessive ground pressure concentration, axle loading failure limitations, and maneuverability constraints when attempting to move such massive structures. The transportation of nuclear reactor vessels, industrial processing equipment, or other heavy loads may require specialized handling systems capable of distributing extreme weight loads while maintaining controlled movement across varying ground conditions.

Existing heavy transport solutions may employ multi-axle trailers or air cushion system mechanisms. These systems may lack the capacity and reliability desirable for heavy loads. Multi-axle trailer systems may include numerous wheel assemblies lacking sufficient capacity. Air cushion platforms may demand continuous power supply for maintaining lift pressure and may be limited by ground surface irregularities. Each approach may involve trade-offs between load capacity, mobility, ground pressure distribution, and operational complexity.

Therefore, there is a need for transport systems that may provide enhanced load distribution, reduced ground pressure, simplified mechanical configuration, and reliable translation capability for ultra-heavy loads across various ground surface conditions.

### SUMMARY

A system configured to transport heavy loads is disclosed in accordance with one or more illustrative embodiments of the present disclosure. In one illustrative embodiment, the system includes a mobile assembly configured to support a load and to translate the load along a ground. In another illustrative embodiment, the mobile assembly includes a platform having an upper surface configured to support the load and an underside surface opposite the upper surface. In another illustrative embodiment, the mobile assembly includes a plurality of rollers configured to be disposed below the underside surface between the underside surface of the platform and the ground. In another illustrative embodiment, the plurality of rollers are configured to support the platform and rotatably translate along the ground to thereby translate the platform along the ground.

In a further aspect, each roller of the plurality of rollers may include a solid cylindrical roller.

In a further aspect, each roller of the plurality of rollers may include a single monolithic material spanning an entirety of a diameter of a cross-sectional area of each roller.

In a further aspect, the plurality of rollers may include stainless steel.

In a further aspect, the plurality of rollers may include a hardened metal.

In a further aspect, the plurality of rollers may be axle-less, and the plurality of rollers may be configured to roll directly on the ground without an axle supporting the plurality of rollers relative to the platform.

In a further aspect, the plurality of rollers may be arranged in one or more rows across a width of the platform.

In a further aspect, the system may include a pair of skirts extending below opposite ends of the platform and, together with the underside surface, defining a roller capture region configured to contain the plurality of rollers at a front end and a rear end during the translation.

In a further aspect, the system may include a pair of side rails extending below opposite sides of the platform perpendicular to the pair of skirts and, together with the underside surface and the pair of skirts, defining the roller capture region configured to contain the plurality of rollers during the translation.

In a further aspect, the system may include the load, and the load may include a reactor vessel of a nuclear power reactor.

In a further aspect, the underside surface adjacent the roller capture region may be configured to withstand rotational frictional contact of the plurality of rollers during the translation of the platform.

In a further aspect, the platform or the side rails may further include a plurality of lubrication ports directed into the roller capture region, where the plurality of lubrication ports are configured to deliver lubricant to the plurality of rollers.

In a further aspect, each lubrication port of the plurality of lubrication ports may be configured to align between two adjacent rollers.

In a further aspect, the plurality of lubrication ports may include grease ports configured to receive grease and to discharge the grease into the roller capture region.

In a further aspect, the platform may be configured to be translated via a tug actuator, and at least one of the tug actuator or a tension member between the tug actuator and the platform may be configured to attach to the platform for the translating of the platform.

In a further aspect, the tension member may include a cable, and the tug actuator may include an electric motor.

In a further aspect, the tension member may be selected to provide a pulling capacity sufficient to move a load over 2,000 metric tons on the platform.

In a further aspect, the system may be configured to transport loads exceeding 2,000 metric tons.

This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are exemplary and explanatory only and are not necessarily restrictive of the subject matter claimed.

### BRIEF DESCRIPTION OF THE DRAWINGS

The detailed description is described with reference to the accompanying figures. The use of the same reference numbers in different instances in the description and the figures may indicate similar or identical items. Various embodiments or examples (“examples”) of the present disclosure are disclosed in the following detailed description and the accompanying drawings. The drawings are not necessarily to scale. In general, operations of disclosed processes may be performed in an arbitrary order, unless otherwise provided in the claims.

FIG. 1A illustrates a side view of a system including a mobile assembly for moving ultra-heavy loads, in accordance with one or more embodiments of the present disclosure.

FIG. 1B illustrates a front view of the system including side rails to further contain the rollers, in accordance with one or more embodiments of the present disclosure.

FIG. 1C illustrates an exploded assembly front view of the system, in accordance with one or more embodiments of the present disclosure.

FIG. 1D illustrates an exploded assembly side view of the system, in accordance with one or more embodiments of the present disclosure.

FIG. 2 illustrates a side view of the system being translated by one or more tug actuators, in accordance with one or more embodiments of the present disclosure.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

Embodiments herein may include and rely upon any components, features, methods, or the like of U.S. Pat. No. 11,410,783, issued Aug. 9, 2022; U.S. Pat. No. 12,087,460, issued Sep. 10, 2024; and/or U.S. patent application Ser. No. 18/793,503, filed Aug. 2, 2024, which are each hereby incorporated by reference in their entirety. For example, a blast mitigation assembly, a containment member, nuclear reactor vessel, and/or any other component or method of one or more of these applications may be used in embodiments of the present disclosure.

Broadly speaking, embodiments of the concepts disclosed herein may provide a system for transporting ultra-heavy loads using roller-based mobile assemblies. The system may include specialized roller-based transport mechanisms configured to distribute extreme weight loads. For example, the system may be configured to transport loads exceeding 1,000 metric tons, or even exceeding 2,000 metric tons. For instance, the system may be configured to move nuclear reactor components, reactor pressure vessels, steam generators, industrial machinery, prefabricated building modules, or the like. By way of another example, the system may include modular transport assemblies that may be scaled or combined based on load requirements. However, note that this is a nonlimiting example and that the system may include any configuration suitable for moving heavy loads across various ground surfaces.

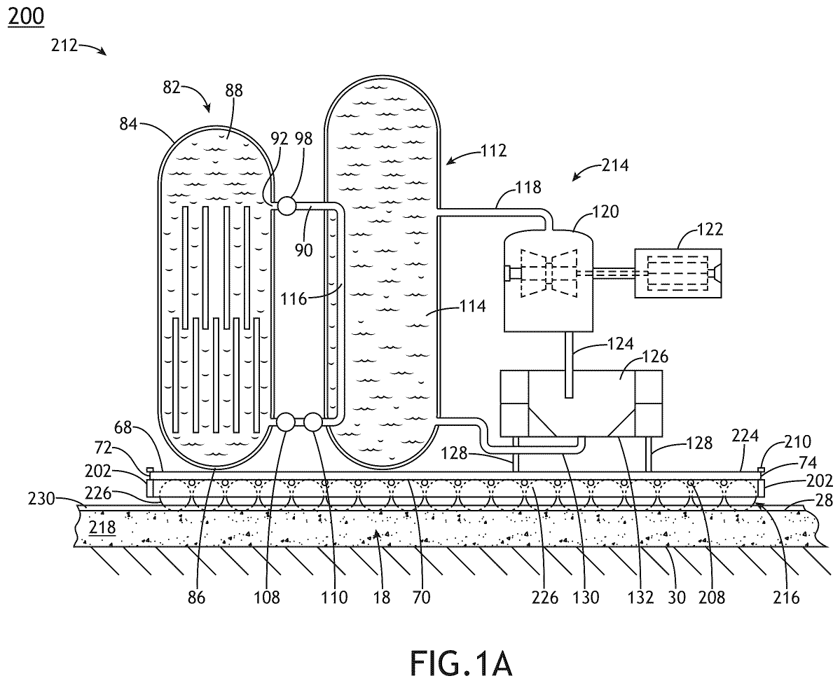

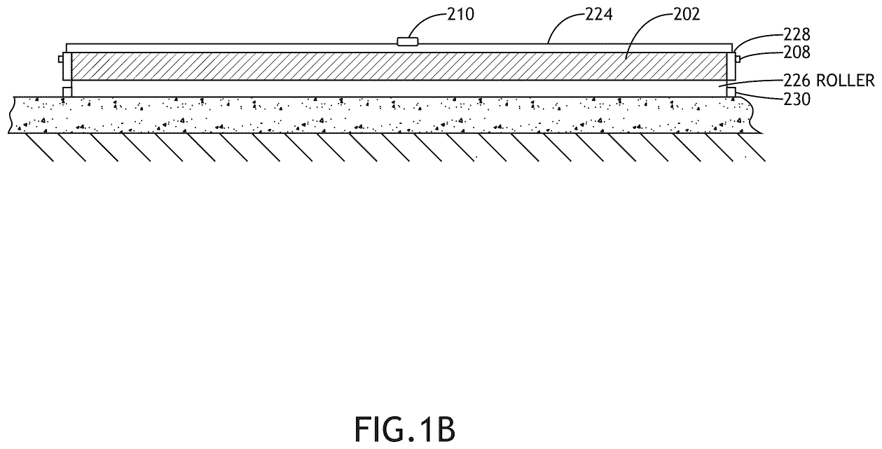

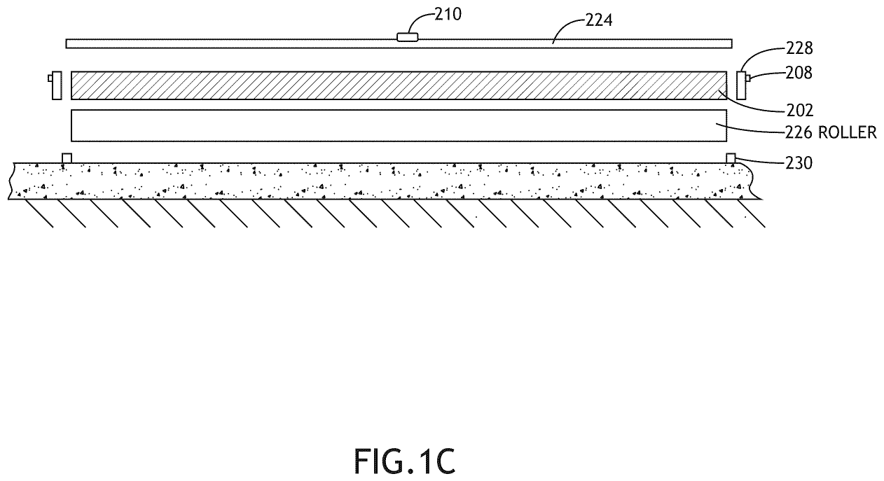

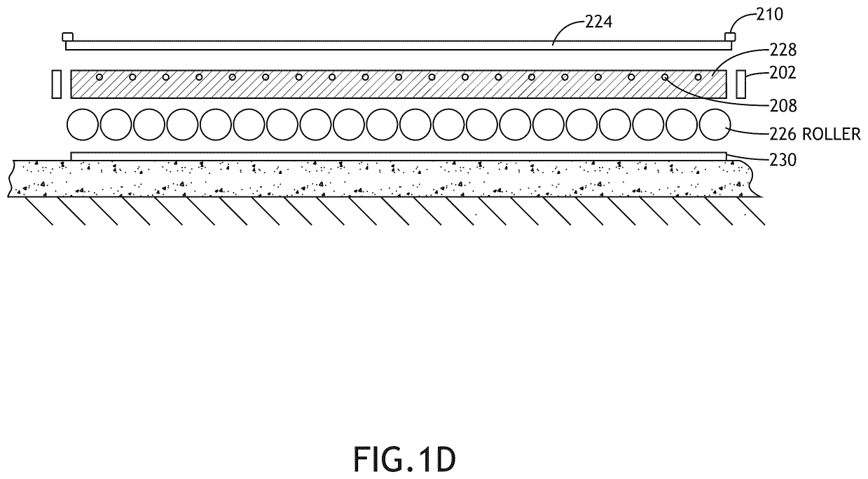

FIG. 1A illustrates a side view of a system 200 including a mobile assembly 212 for moving ultra-heavy loads (e.g., loads weighing more than 2,000 metric tons), in accordance with one or more embodiments of the present disclosure. The system 200 may be configured to transport heavy loads.

In embodiments, the system 200 includes a mobile assembly 212 configured to support a load 214 and to translate the load 214 along a ground 218. For example, the mobile assembly 212 may be configured to roll along the ground 218.

The mobile assembly 212 may include a platform 224 including an upper surface 68 configured to support the load 214 and an underside surface 70 opposite the upper surface 68. For example, the platform 224 may include any suitable shape for supporting the load 214, such as a flat plate shape. The platform 224 may include high-strength steel alloy construction, reinforced concrete composite structures, or aluminum alloy frameworks. By way of another example, the platform 224 may include carbon fiber reinforced polymer layers, titanium alloy components, or hybrid metal-composite laminates. The platform 224 may include integrated reinforcement ribs, trusses, or beam networks distributed across the platform 224. However, note that this is a nonlimiting example and that the platform 224 may include any material or structural configuration suitable for supporting and distributing heavy loads.

The mobile assembly 212 may further include a plurality of rollers 226 configured to be disposed below the underside surface 70 between the underside surface 70 of the platform 224 and the ground 218. The plurality of rollers 226 may be configured to support the platform 224 and to rotatably translate (e.g., roll) along the ground 218 to thereby translate the platform 224 along the ground 218.

The plurality of rollers 226 may include any structural configuration suitable for bearing and translating ultra-heavy loads such as those in excess of 2,000 metric tons. For example, each roller 226 may be a solid cylindrical roller. Each roller 226 may include a single monolithic material spanning an entirety of a diameter of a cross-sectional area of each roller 226. In other words, the material may be completely solid across its width.

The plurality of rollers 226 may include stainless steel. The plurality of rollers 226 may include a hardened metal. For instance, the plurality of rollers 226 may include tool steel, bearing steel, and/or maraging steel compositions. By way of another example, the plurality of rollers 226 may include tungsten carbide, silicon carbide ceramics, and/or cermet materials. The plurality of rollers 226 may include surface treatments such as chrome plating, nitriding, carburizing, or diamond-like carbon coatings. For instance, each roller 226 may include a hardness rating between 55 and 65 HRC (Rockwell C scale). The plurality of rollers 226 may include diameters ranging from 100 millimeters to 500 millimeters or any suitable dimension based on load requirements. The plurality of rollers 226 may be manufactured using various processes. For example, the plurality of rollers 226 may be produced through hot forging, cold drawing, or centerless grinding operations. For instance, the plurality of rollers 226 may undergo heat treatment cycles including quenching, tempering, or cryogenic processing. In this way, rather than multiple components such as inflatable tires or the like, the rollers 226 may include a hard material or any other suitable material configured to withstand high loads and minimize deformation. However, note that this is a nonlimiting example and that the plurality of rollers 226 may include any material composition, surface treatment, or dimensional configuration suitable for rolling support of heavy loads.

In some embodiments, the plurality of rollers 226 are axle-less. The plurality of rollers 226 may be configured to roll directly on the ground 218 without an axle supporting the plurality of rollers 226 relative to the platform 224. For example, the axle-less configuration may eliminate bearing assemblies, reducing maintenance requirements and failure points. For instance, each roller 226 may freely migrate within the roller capture region 216 during translation, self-organizing based on load distributions.

The plurality of rollers 226 may be arranged in one or more rows across a width of the platform 224.

The plurality of rollers 226 may be packed tightly proximate to each other, or may be spaced apart. For example, adjacent rollers 226 may be separated by gaps ranging from 0.5 millimeters to 50 millimeters. For instance, the plurality of rollers 226 may be arranged in a close-packed configuration where each roller 226 contacts adjacent rollers 226. By way of another example, the plurality of rollers 226 may be arranged with uniform spacing maintained by separator elements (e.g., plates, or rotational separators), guide channels, or positioning frameworks. The spacing between rollers 226 may vary across the width or length of the platform 224 to accommodate different load distributions. For instance, higher roller 226 density may be provided in central regions experiencing greater loads while lower density may be provided at peripheral regions. The plurality of rollers 226 may include between 10 and 500 individual rollers 226 or any suitable quantity based on platform 224 dimensions and load 214 requirements. However, note that this is a nonlimiting example and that the plurality of rollers 226 may include any spacing arrangement or quantity suitable for load distribution and translation.

The system 200 may further include a pair of skirts 202 extending below opposite ends of the platform 224, such as a front and rear of the platform 224. The pair of skirts 202, together with the underside surface 70, may define a roller capture region 216 configured to contain the plurality of rollers 226 at a front end and a rear end during the translation.

The pair of skirts 202 may extend from the front and rear ends of platform 224 to contain the plurality of rollers 226.

The underside surface 70 adjacent the roller capture region 216 may be configured to withstand rotational frictional contact of the plurality of rollers 226 during the translation of the platform 224. The rollers 226 may be lubricated to spin and rub against the underside surface 70 of the platform 224. However, in some embodiments, the rollers 226 may be free to roll along the underside surface 70 of the platform 224, without rubbing and without skirts. The underside surface 70 may include wear-resistant coatings, hardened steel plates, or replaceable wear strips to extend operational life. However, note that this is a nonlimiting example and that any lubrication type, application method, or surface treatment suitable for reducing friction and wear may be employed.

The platform 224 and/or the side rails 228 may further include a plurality of lubrication ports 208 directed into the roller capture region 216. The plurality of lubrication ports 208 may be configured to deliver lubricant to the plurality of rollers 226, such as being configured to receive grease from a grease gun orifice and pass the grease through the mobile assembly 212 into the roller capture region 216.

Each lubrication port 208 of the plurality of lubrication ports 208 may be configured to align between two adjacent rollers 226. Each lubrication port 208 of the plurality of lubrication ports 208 may be configured to be in between the rotational axis of the rollers 226. The plurality of lubrication ports 208 may include grease ports (e.g., grease zerks) configured to receive grease and to discharge the grease into the roller capture region 216.

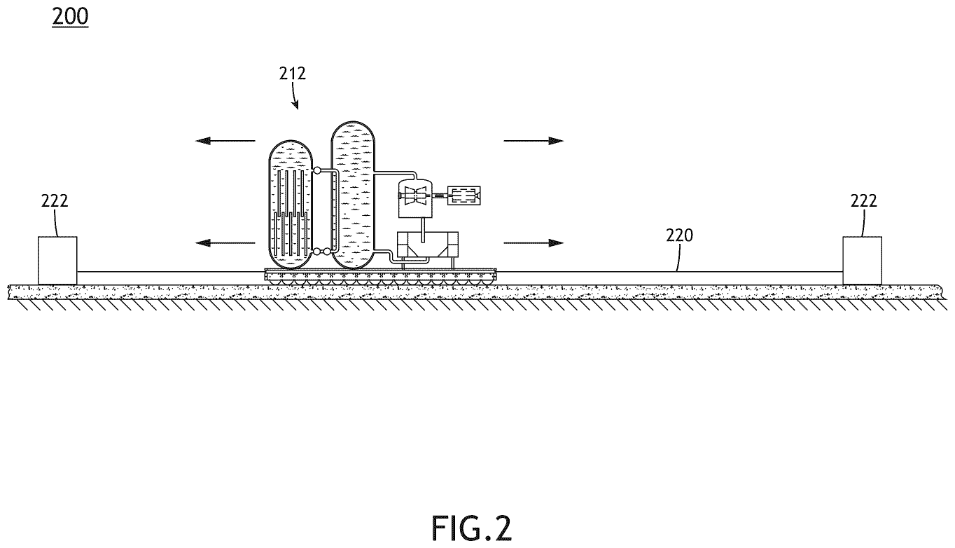

The mobile assembly 212 may further include one or more couplable interfaces 210 coupled to the platform 224 and configured to couple to a tug actuator 222 (e.g., see FIG. 2) via a tension member 220 (e.g., see FIG. 2) to provide a location from which to pull the mobile assembly 212 back and forth. The platform 224 may include a first end 72 and second end 74 and one or more couplable interfaces 210 may be coupled (e.g., welded, bolted) to each end 72, 74.

The couplable interface 210 may include suitable feature or void/slot. For example, the couplable interface 210 may include an aperture (e.g., slot) configured to receive a hook or the like. The aperture may be built into the platform 224 itself, or extending out from the platform or the like. The couplable interface 210 may include any mechanical interface such as at least one cable or hook attachment interface. For example, the couplable interface 210 may include shackles, clevises, eye bolts, or swivel hoist rings. For instance, the couplable interface 210 may include load ratings between 100 tons and 1,000 tons per attachment point. By way of another example, the couplable interface 210 may include multiple attachment points enabling load distribution across several tension members 220. The couplable interface 210 may include pintle hooks, pelican hooks, or self-locking mechanisms preventing inadvertent release. For instance, the couplable interface 210 may include load cells, strain gauges, or force monitoring sensors providing real-time tension feedback. The couplable interface 210 may include universal joints, articulating connections, or multi-axis pivot points accommodating angular misalignment. However, note that this is a nonlimiting example and that the couplable interface 210 may include any type of mechanical attachment suitable for transferring pulling forces to the platform 224.

The load 214 may include any physical structure that can be supported and moved. For example, the load 214 may be, but is not required to be, a reactor vessel 82 of a nuclear power reactor, a reactor pressure vessel, a steam generator, a turbine generator assembly, a petrochemical processing vessel, a bridge section, or a pre-assembled modular building structure. By way of another example, the load 214 may include aerospace components such as rocket booster sections or aircraft fuselage assemblies. For instance, the load 214 may include offshore oil platform modules, wind turbine components, or large-scale manufacturing equipment. The load 214 may include structures having irregular geometries, asymmetric weight distributions, or multiple interconnected components. However, note that this is a nonlimiting example and that the load 214 may include any object or assembly requiring ground-based transport regardless of weight, size, or configuration.

As a nonlimiting description of an embodiment of a load 214, the nuclear power reactor may include a reactor vessel 82. The load 214 may include a bottom wall 18 with an upper side 28 and lower side 30. To provide a stabilized operating surface, a ground track or base plate 18 (upper side 28, lower side 30) may be deployed beneath the rollers 226. Mounted on platform 224 are: a vessel 82 having upper end 84, lower end 86, and interior compartment 88; a heat exchanger 112 having interior compartment 114; and a condenser 126 having lower side 132 and elevated by legs 128. A pipe 90 has inner end 92 in fluid communication with interior compartment 88 and includes valve 98. Pipe 90 connects to pipe 116 inside heat exchanger 112. A steam line 118 extends from interior compartment 114 to turbine 120, which drives generator 122. Return line 124 extends from turbine 120 to condenser 126. A pump 110 and valve 108 are provided in the return circuit. Line 130 extends from lower side 132 of condenser 126 back to interior compartment 114 of heat exchanger 112.

Although hidden for clarity purposes only, the mobile assembly 212 may include side rails to contain the ends of the rollers 226.

FIG. 1B illustrates a front view of the system 200 including the side rails 228 to further contain the rollers 226, in accordance with one or more embodiments of the present disclosure.

Similar to the skirts 202 at each end (e.g., front and back) of the platform 224, the side rails 228 may be configured to further contain the rollers 226. The side rails 228 may extend below opposite sides of the platform 224, perpendicular to the front and rear of the platform 224 and perpendicular to the pair of skirts 202. The pair of side rails 228, together with the underside surface 70 and the skirts 202, may define a roller capture region 216 configured to contain the plurality of rollers 226 during the translation.

Each lubrication port 208 may pass through a side rail 228 as shown, such as through a hole in the side rail 228.

In embodiments, the system 200 may include one or more tracks 230 (e.g., rails) configured to be attached to the ground 218. The rollers 226 may roll between the tracks 230 and/or on the tracks 230. For example, the tracks 230 may be configured to guide the plurality of rollers 226 during the translation of the platform 224. For example, the tracks 230 may be positioned adjacent to outer ends of the plurality of rollers 226. For instance, the tracks 230 may extend upward from the ground 218 by a height sufficient to provide guidance to the plurality of rollers 226. By way of another example, the tracks 230 may include raised rails, guide channels, or boundary structures positioned alongside the plurality of rollers 226. The tracks 230 may be configured to maintain alignment of the mobile assembly 212 along a predetermined path during translation. For instance, the tracks 230 may include metal rails, or concrete curbs. By way of another example, the tracks 230 may extend along an entire length of a travel path or may be positioned at select intervals along the travel path. The tracks 230 may include a height ranging from 10 millimeters to 200 millimeters above the ground 218. However, note that this is a nonlimiting example and that the tracks 230 may include any configuration, height, material composition, or positioning suitable for guiding the plurality of rollers 226 during translation of the mobile assembly 212.

FIG. 1C illustrates an exploded assembly front view of the system 200, in accordance with one or more embodiments of the present disclosure. FIG. 1D illustrates an exploded assembly side view of the system 200, in accordance with one or more embodiments of the present disclosure.

While certain components like the side rail 228 are shown as separated in the exploded assembly view, such separation is nonlimiting and for illustrative purposes only. For example, components such as the side rail 228 may be permanently attached (e.g., welded) to the platform 224 or the like.

In embodiments, the side rails 228 may include longitudinal grooves configured to receive corresponding smaller diameter ends of the plurality of rollers 226. For example, each side rail 228 may include an inwardly-facing groove configured to accommodate a reduced-diameter end portion of each roller 226. For instance, the rollers 226 may include stepped cylindrical configurations where central body sections maintain a first diameter while end sections include a second diameter smaller than the first diameter. By way of another example, the grooves may include machined grooves, formed channels, or integrated protruding guide rails extending along an interior surface of each side rail 228. The grooves may be configured to maintain alignment of the plurality of rollers 226 while permitting rotational movement during translation. For instance, the reduced-diameter end portions of the rollers 226 may include clearance fits. By way of another example, the depth of the grooves may range from 5 millimeters to 50 millimeters. The grooves may include wear-resistant coatings, hardened steel inserts, or replaceable liner elements configured to withstand repeated contact with the roller 226 end portions. However, note that this is a nonlimiting example and that the side rails 228 may include any groove configuration and the plurality of rollers 226 may include any end geometry suitable for guided rolling translation within the roller capture region 216.

FIG. 2 illustrates a side view of the system 200 being translated by one or more tug actuators 222, in accordance with one or more embodiments of the present disclosure.

Each tug actuator 222 may be configured to pull the platform 224. For example, each tug actuator 222 may be configured to pull the platform 224 via a couplable interface 210 and thereby provide for the translation of the platform 224 and the load 214. For example, the mobile assembly 212 may include a couplable interface 210 on each end.

The tug actuator 222 may include any suitable actuator configured to pull heavy loads, such as an electric motor. For example, the tug actuator 222 may include hydraulic cylinders, pneumatic actuators, or winch systems. However, note that this is a nonlimiting example and that the tug actuator 222 may include any type of mechanical, electrical, hydraulic, or hybrid actuation system suitable for translating the mobile assembly 212.

The tension member 220 may include any suitable element such as a cable or chain. The tension member 220 may be selected to provide a pulling capacity sufficient to move a load 214 over 2,000 metric tons on the platform 224.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “in embodiments”, “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination or sub-combination of two or more such features, along with any other features which may not necessarily be expressly described or inherently present in the instant disclosure.

It is to be understood that embodiments of the methods disclosed herein may include one or more of the steps described herein. Further, such steps may be carried out in any desired order and two or more of the steps may be carried out simultaneously with one another. Two or more of the steps disclosed herein may be combined in a single step, and in some embodiments, one or more of the steps may be carried out as two or more sub-steps. Further, other steps or sub-steps may be carried out in addition to, or as substitutes to one or more of the steps disclosed herein.

Although inventive concepts have been described with reference to the embodiments illustrated in the attached drawing figures, equivalents may be employed and substitutions made herein without departing from the scope of the claims. Components illustrated and described herein are merely examples of a system/device and components that may be used to implement embodiments of the inventive concepts and may be replaced with other devices and components without departing from the scope of the claims. Furthermore, any dimensions, degrees, and/or numerical ranges provided herein are to be understood as non-limiting examples unless otherwise specified in the claims.

What is claimed:

1. A system configured to transport heavy loads, the system comprising:
a mobile assembly configured to support a load and to translate the load along a ground, wherein the mobile assembly comprises:
a platform having an upper surface configured to support the load and an underside surface opposite the upper surface; and
a plurality of rollers configured to be disposed below the underside surface between the underside surface of the platform and the ground, wherein the plurality of rollers are configured to support the platform and rotatably translate along the ground to thereby translate the platform along the ground.

2. The system of claim 1, wherein each roller of the plurality of rollers comprises a solid cylindrical roller.

3. The system of claim 2, wherein each roller of the plurality of rollers comprises a single monolithic material spanning an entirety of a diameter of a cross-sectional area of each roller.

4. The system of claim 2, wherein the plurality of rollers comprise stainless steel.

5. The system of claim 2, wherein the plurality of rollers comprise a hardened metal.

6. The system of claim 1, wherein the plurality of rollers are axle-less, wherein the plurality of rollers are configured to roll directly on the ground without an axle supporting the plurality of rollers relative to the platform.

7. The system of claim 1, wherein the plurality of rollers are arranged in one or more rows across a width of the platform.

8. The system of claim 1, further comprising:
a pair of skirts extending below opposite ends of the platform and, together with the underside surface, defining a roller capture region configured to contain the plurality of rollers during the translation at a front end and a rear end.

9. The system of claim 8, further comprising a pair of side rails extending below opposite sides of the platform perpendicular to the pair of skirts and, together with the underside surface and the pair of skirts, defining the roller capture region configured to contain the plurality of rollers during the translation.

10. The system of claim 9, wherein the pair of side rails each comprise a inwardly-facing groove configured to receive a reduced-diameter end portion of each roller.

11. The system of claim 8, wherein the system comprises the load, wherein the load comprises a reactor vessel of a nuclear power reactor.

12. The system of claim 8, wherein the underside surface adjacent the roller capture region is configured to withstand rotational frictional contact of the plurality of rollers during the translation of the platform.

13. The system of claim 8, wherein the mobile assembly further comprises:
a plurality of lubrication ports directed into the roller capture region, wherein the plurality of lubrication ports are configured to deliver lubricant to the plurality of rollers.

14. The system of claim 13, wherein each lubrication port of the plurality of lubrication ports is configured to align between two adjacent rollers.

15. The system of claim 13, wherein the plurality of lubrication ports comprise grease ports configured to receive grease and to discharge the grease into the roller capture region.

16. The system of claim 1, wherein the platform is configured to be translated via a tug actuator, wherein at least one of the tug actuator or a tension member between the tug actuator and the platform is configured to attach to the platform for the translating of the platform.

17. The system of claim 16, wherein the tension member comprises a cable, wherein the tug actuator comprises an electric motor.

18. The system of claim 16, wherein the tension member is selected to provide a pulling capacity sufficient to move a load over 2,000 metric tons on the platform.

19. The system of claim 1, further comprising one or more tracks configured to be attached to the ground and configured to guide the plurality of rollers during the translating of the platform.

20. The system of claim 19, wherein the one or more tracks are configured to be positioned adjacent to outer ends of the plurality of rollers.
